(19) United States
(12) Patent Application Publication
(10) Pub. No.: US 2023/0094667 A1
(43) Pub. Date: Mar. 30, 2023

(54) APPARATUS AND METHOD FOR FORMING A SUBSTITUTE PRODUCT FOR A HOLLOWED-OUT BAGEL

(71) Applicant: David Moshe Jackson, Highland Park, IL (US)

(72) Inventor: David Moshe Jackson, Highland Park, IL (US)

(21) Appl. No.: 17/449,191

(22) Filed: Sep. 28, 2021

(51) Int. Cl. A21C 11/00; A21D 13/40; A21D 13/32; A47J 37/01

(52) U.S. Cl. CPC A21C 11/002; A21D 13/40; A21D 13/32; A47J 37/01

(57) ABSTRACT

An apparatus and method for baking a hollowed-out bagel substitute product is disclosed. A composite tray is provided with a tray portion that supports bread dough within tray cups, and a cover portion that sits on top of the tray portion. In use, gravitational forces on the cover portion retain it in place, with a gap defined between the cover portion and the tray portion that contributes to a resultant shape of the substitute product after the bread dough rises and is baked.

### BACKGROUND OF THE INVENTION

The present invention relates to hollowed-out bagels and, more particularly, to a two-part baking tray for forming a substitute product for a hollowed-out bagel.

At the present, there is no good way to bake a hollowed-out bagel (i.e., removing a substantial amount of the dough from the outer shell portion). Currently, consumers must resort to obtaining conventional bagels and hollow out the dough by hand to reduce calories of the bagel. This wastes dough and is a time-consuming process for the consumer. This same problem equally applies to bakeries and other locations that sell hollowed-out bagels.

Existing products for hollowing out other forms of baked goods (such as cake mixes and other desserts) are complex and are not suitable for forming a hollowed-out bagel. Many require moving parts and/or electricity, complex structures, multiple baking steps, different materials, etc. These solutions are inefficient and are specifically configured for the baked good they were designed for, leaving consumers and bakeries with the task of self-forming their own hollowed out bagels.

As can be seen, there is a long-felt need for a two-part mold and method of creating a product similar in form and function to a hollowed-out bagel.

### SUMMARY OF THE INVENTION

In one aspect of the present invention, a composite tray for baking a hollow bread product comprises: a tray portion comprising a plurality of lower cups, the plurality of lower cups being configured to receive bread dough therewithin; and a cover portion comprising a plurality of upper cups, with each upper cup of the plurality of upper cups axially aligning with a respective lower cup of the plurality of lower cups, wherein the cover portion is configured to rest on the tray portion and be retained in place via gravitational forces, with a predetermined gap being defined between the cover portion and the tray portion, and the plurality of lower cups and the plurality of upper cups are configured to sandwich the bread dough within the predetermined gap.

In another aspect of the present invention, a method of baking hollow bread product comprises the steps of: providing a composite tray comprising: a tray portion comprising a plurality of lower cups; and a cover portion comprising a plurality of upper cups, with each upper cup of the plurality of upper cups axially aligning with a respective lower cup of the plurality of lower cups; placing bread dough within the plurality of lower cups; resting the cover portion on the tray portion, with the cover portion being retained in place via gravitational forces, and with a predetermined gap being defined between the cover portion and the tray portion, and the plurality of lower cups and the plurality of upper cups sandwiching the bread dough within the predetermined gap.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention;

FIG. 2 is a top plan view of the embodiment of the present invention;

FIG. 3 is a front elevation view of the embodiment of the present invention;

FIG. 4 is cross-sectional view of the embodiment of the present invention, taken on line 4-4 of FIG. 2;

FIG. 5 is a detail cross-sectional view of the embodiment of the present invention, indicated by line 5-5 of FIG. 4; and

FIG. 6 is an exploded elevational view of the embodiment of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

Broadly, one embodiment of the present invention is a composite tray that includes a lower, tray portion that dough is placed on and an upper, cover portion that is placed over top the tray portion. In use, the dough rises to form a hollow shape around a gap in the two portions. There is no similar process, mold, or method as detailed herein, and there are no similar end-products as that of the present invention.

An end result of practicing teachings of the present invention is a bowl-shaped (i.e., hollow) bread product (made from, preferably, sourdough), which is similar in form and function to a hollowed-out bagel (and serves as a substitute product therefor). As presently embodied, the resultant product has an outer diameter slightly wider that a typical bagel and a height (i.e., thickness of the bagel) suitable to fit in a toasting slot of a typical pop-up toaster, thereby allowing embodiments of the present invention to easily be toasted based on a user's preferences. After production thereof, the bread product can be frozen until heated/toasted when served. When baked, the exterior curved walls are crunchy, the base (i.e., bottom portion of the bread product when laid down horizontally) of the exterior is crunchy, and the base of the interior is slightly bready/springy.

By creating this form, a depth of the interior of the bread product is configured for receiving one or more fillings. Depending on the filling and toasting preferences, the time in the toaster can be adjusted accordingly for the desired result.

Sourdough is typically used for its unique flavor and other bread types are not recommended. The air bubbles and lightness of the sourdough crafted into this shape is of paramount importance in terms of delivering a high-quality final product. The dough is not a flowable product like a cake mix. Further, it is not pressed into the tray to form the shape, as that would result in a product that is too brittle. For that reason, the composite tray discussed herein does not include clamps, rods, or presses.

Best results are yielded through use of one-half inch thick rolled sourdough discs of standard, predetermined dimensions. These are placed in a dough bowl receptacle (the female, lower tray portion) and covered with the male mold (the upper, cover portion) which have upper cups that are a shape and size narrower by a predetermined amount relative to lower cups of the tray portion to create the dimensions the sides and the base of the bowl shape. When placed therebetween, the dough will naturally rise to fill a gap between the two parts over a predetermined proofing time. The process, described herein, uses a traditional sourdough recipe, and essential care is taken to preserve the aerated bubbles which are a signature of the look of the final product. While yeast can be used, the product is made with “starter” made of flour and water. Further, there are no preservatives or additives other than salt. In certain embodiments, the exterior can include an egg wash, poppyseed, sesame, and other appropriate coatings.

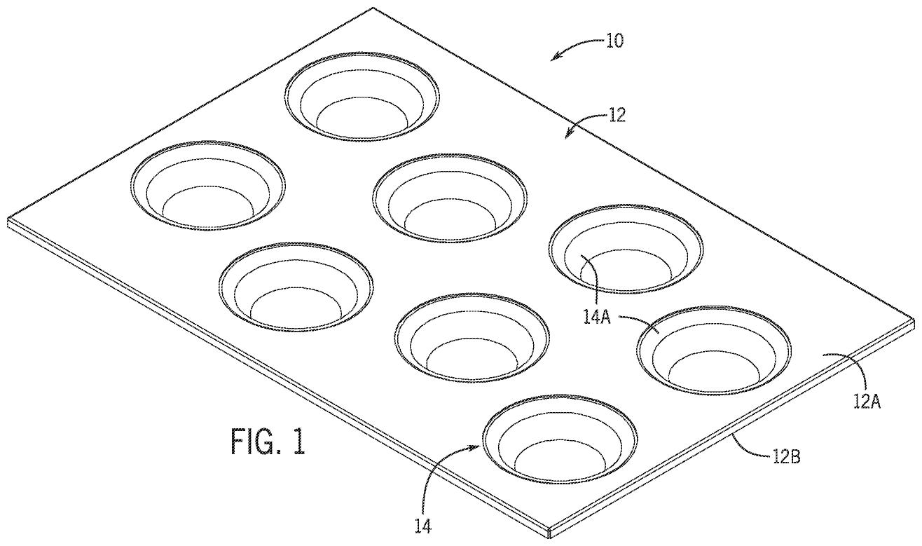

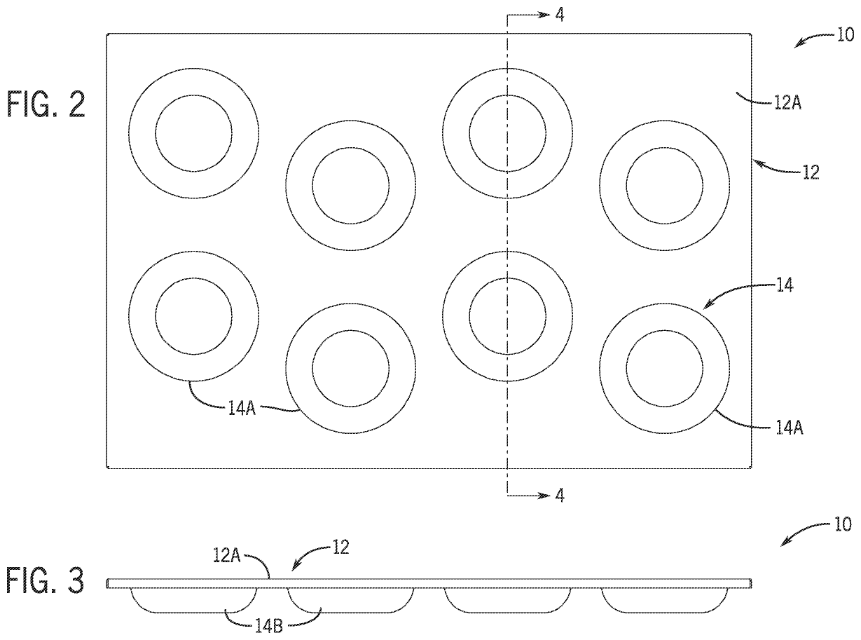

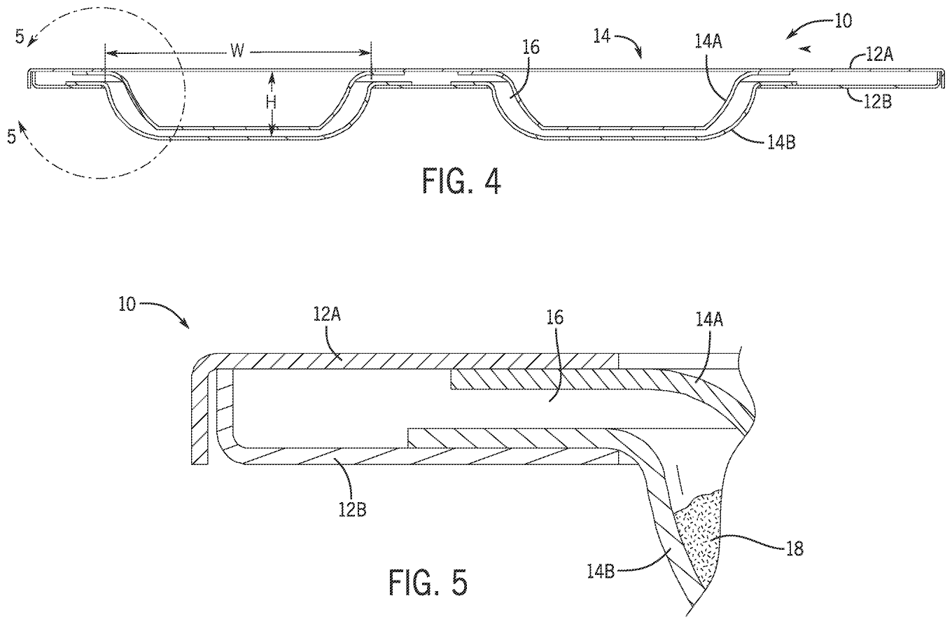

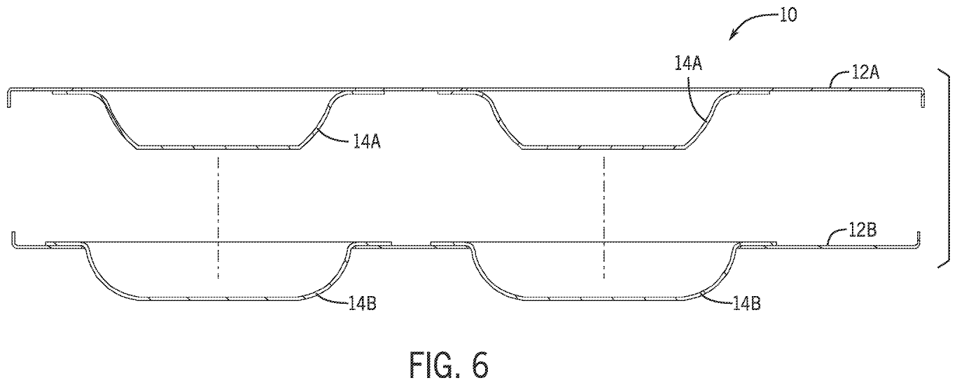

Referring to FIGS. 1-6, a bread (preferably, sourdough) product system 10 may include, as its primary physical component, a composite tray 10. The composite tray 12 includes two portions, namely an upper, cover portion 12A and a lower, tray portion 12B. In preferred embodiments, the cover portion 12A and the lower, tray portion 12B are formed from stainless steel (which can, consequently, be used in an oven and are not microwaveable). As shown in FIGS. 1 and 3, the composite tray 12 includes a plurality of indented cups 14, with the cover portion 12A having a plurality of upper cups 14A and the tray portion having a plurality of lower cups 14B that are axially aligned with one another when the cover portion 12A is placed on the tray portion 12B (e.g., moving from the position shown in FIG. 6 to the position shown in FIG. 4). As shown, for example, in FIGS. 2, 4 and 6, each upper cup 14A defines an arcuate, ring-shaped sidewall, with the sidewall of the upper cup 14A having a different profile shape (i.e., when viewed in cross-section, like in FIGS. 4 and 4) than a profile shape of the sidewall of the lower cup 14B. Each upper cup 14A also has a substantially planar, circular bottom surface. Each lower cup 14B also defines a substantially planar, circular bottom surface and an arcuate, ring-shaped sidewall (which, as mentioned above, if differently shaped compared to the upper cup 14A).

As shown in FIGS. 4 and 5, an upwardly extending lip of the tray portion 12B serves as a surface for the cover portion 12A to rest on, resulting in a gap 16 of predetermined size between the two portions 12A, 12B, which is the space in which the dough 18 rests and is allowed to proof, rise, and bake, as explained in greater detail below. In certain embodiments, the gap 16 is approximate ¼ inches between the bottom surfaces of the upper cups 14A and lower cups 14B, and approximately ⅜ inches between the sidewalls of the upper cups 14A and lower cups 14B. As indicated by the lettering in FIG. 4, cups 14 of the composite tray 12 result in a hollowed-out bowl shape with an approximately predetermined width W and height H. The rising of the dough 18 in the designed gap 16 between the two portions 12A, 12B creates a bowl-shaped bread product (as mentioned above, similar in form and function to a hollowed-out bagel to achieve the same overall purpose). Thus, the present invention provides for a hollow product that can receive any number of desired fillings.

The composite tray 12 may be formed by any appropriate process. For example, a sheet of stainless-steel may be stamped to shape and size. The cups 14 may be formed as separate parts that are then permanently affixed to a larger overall sheet (the portions 12A, 12B being separate sheets), or, in certain embodiments, formed as part of the larger overall sheet. Those with skill in the art will appreciate that other processes of forming the composite tray 12 may be used in accordance with the present invention, such that the overall end-product composite tray 12 described herein is achieved.

In accordance with the present invention, the following process may be utilized to form the aforementioned bagel-substitute bread product. It will be appreciated that certain steps may be performed in different orders than the method described (the ordering of the steps is primarily intended to differentiate them from one another), or may be entirely omitted depending upon the desired end result (as well as the fact that some of the steps described simply describe how to make the dough), as well as other minor modifications that would be apparent to those with skill in the art. The described process is only intended to educate the reader on one way to practice the present invention, which is only limited by the claims that follow.

An initial preparation stage may include the following:
1. A water and flour starter is cultivated until aerated and able to float on water.
2. The starter is mixed with water.
3. Flour is added and kneaded.
4. A predetermined amount of time of bench rest is allowed (e.g., 30 minutes).
5. Salt and additional water is added and mixed in.
6. The dough is folded and turned to stretch it in intervals (e.g., every half an hour for a total of 4 hours). Aeration bubbles may be noted/observed in this step, which is a hallmark of sourdough.
7. The dough is removed from the bowl and, optionally, shaped into a circular shape using a bench knife. Optionally, a predetermined amount of bench rest time is allowed (e.g., 35 minutes), during which time it will start to flatten out.
8. The dough is rolled flat with rolling pin set to a height of, for example, ⅜ or ½ inch above counter (taking care to preserve air bubbles).
9. The ⅜ or ½ inch high dough circles of predetermined standard diameter are stamped out.
10. Optionally, the dough circles are brushed with egg wash on one side.

An intermediate composite tray preparation and baking stage may include the following:
11. The top side of the lower cups 14B and the bottom side of the upper cups 14A are sprayed with olive oil.
12. The dough circles are placed in the lower cups 14B and, if egg wash is used, with the coating side down.
13. The tray portion 12B is next covered with the cover portion 12A (they fit together as shown in FIGS. 4 and 5). Importantly, the portions 12A, 12B are not clamped, nor is additional pressure applied (besides the weight of the cover portion), so that the air bubbles will not be deflated (else the bread cup will be brittle). The desired outcome after baking with this arrangement will be a springy interior base of the cup and a slightly crunchy exterior of the sides and wall and exterior of the base. When initially closed, there is no visible gap (at the lips disposed along the peripheral edges) between the portions 12A, 12B (at that stage the molds have the ⅜ or ½ inch round in the base lower cups 14B and no rise up the sides).
14. The dough is allowed to proof in the mold for, e.g., 3-5 hours at 84 degrees or up to 12 hours if refrigerated, during which time the dough will rise in the gap between the molds and fill the cavity. After the dough rises, a visible gap occurs between the lips at peripheral edges of the portions 12A, 12B due to the dough rising and expanding during the proofing process up the sides of the cavity and to the top. The amount of the rise will relate to the amount of proofing time and the temperature.
15. The composite tray 12, containing the risen dough, is placed in a pre-heated oven.
16. The composite tray 12 is removed from the oven and opened. The dough is baked such that a cup/bowl (i.e., a bread product that forms a cup/bowl shape) is formed that will still be flexible after baking. The bread products are removed and placed on cooling trays.
17. After cups have cooled, the predetermined circumference is stamped out and any excess baked dough can be removed (such that the cups will be uniform).

A packaging, storage, and consumption stage may include the following:
18. The bread products are placed in sealable bag (with, for example, metal foldbacks), and the bag is folded and stored in a freezer.
19. The bag with frozen bread products is removed from the freezer, and the bread products a user wishes to eat may be removed from the bag. The bag with remaining bread products may be refolded and placed back in the freezer.
20. The bread product(s) may be placed in a pop-up toaster and toasted at desired setting.
21. The toasted product is extracted from the toaster. The product is no longer flexible like prior to freezing but is still springy in the interior base of the cup/bowl and crunchy on exterior.
22. The product may be eaten plain or filled with hot, cold, sweet, or savory filling. The process in which the cup was made permits it to be eaten with one hand and any fillings will not fall out.

In alternative embodiments, a screw hole may be provided that can be used to hold the cover portion 12A and tray portion 12B together, but that is disregarded in the previously described process because it would unduly squeeze and compact the dough. Rather, gravity is used to hold the portions 12A, 12B together.

In summary, the present invention permits for a hollowed-out bagel substitute to be formed at the point of baking, which had previously never been possible. The design/shape is very specific, to that end, as described above, to make the bowl shape. There are no interchangeable or different cups 14 used. For example, there is no cone shape, roll shape, ball/spherical shapes, bun shape or bread loaf shape or pocked interiors with cavities, for example, nor are there any insertion rods to form a bun or hollow a bagel. The cups 14 do not have cavities in them for filling.

No electricity, power, or mechanical machines are required to be coupled to the composite tray 12 in order for the tray 12 to function as intended (besides it being placed, for example, in the oven). Further, due to the properties/composition of sourdough used, it should not and cannot be pressed or injected or clamped. Therefore, it is unlike other male/female baking apparatuses and is not used for dessert and cake mixes nor any kind of pressed dough to make it flowable. In terms of aeration, there are no pinholes, grooves, or channels in the cover portion 12A and the tray portion 12B. Unlike other conventional molds that may utilize those (i.e., utilize some form of connecting member/fastener to couple the mold), a non-pressed natural rising process is sufficient and preferred.

Another advantage is that the process utilized is a single step baking process and does not rely on different materials with different heating coefficients or a multistage baking process. There is no boiling required, unlike that which is specific to making a bagel product. The process is simplified by the design wherein the cover portion 12A rests on the tray portion 12B. Both portions 12A, 12B, as described above are both an array of fixed cups 14 set in a stainless-steel tray of size typical to baking racks (this is not microwaveable and plastic or other materials are not used). There is no side insertion or L-shaped process (as for a hollowed-out bread loaf), or movable/interchangeable cups, for example, and no different shapes of bread products can be made. However, those with skill in the art that variations in size may be appropriate. For example, the tray 12 may be enlarged to accommodate additional cups 14, where a larger oven is used, and the size of the cups 14 may vary depending on size of bread product desired. These modifications would likely require slightly different baking times, which can be determined by those with skill in the art who practice the teachings of the present invention.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A composite tray for baking a hollow bread product, the composite tray comprising:
a tray portion comprising a plurality of lower cups, the plurality of lower cups being configured to receive bread dough therewithin; and
a cover portion comprising a plurality of upper cups, with each upper cup of the plurality of upper cups axially aligning with a respective lower cup of the plurality of lower cups,
wherein the cover portion is configured to rest on the tray portion and be retained in place via gravitational forces, with a predetermined gap being defined between the cover portion and the tray portion, and the plurality of lower cups and the plurality of upper cups are configured to sandwich the bread dough within the predetermined gap.

2. The composite tray of claim 1, wherein no connecting members are used to retain the tray portion in place with the cover portion.

3. The composite tray of claim 1, wherein the tray portion comprises an upwardly-extending tray lip that extends around peripheral edges of the tray portion, the tray lip supporting the cover portion.

4. The composite tray of claim 3, wherein the cover portion comprises a downwardly-extending cover lip disposed proximate the tray lip when the cover portion rests on the tray portion.

5. The composite tray of claim 4, wherein the cover portion is supported and retained in place via substantially only gravitational forces, the tray lip, and the cover lip.

6. The composite tray of claim 1, wherein the cover portion and the tray portion are formed from stainless-steel.

7. The composite tray of claim 1, wherein the cover portion is configured to be vertically displaced relative to the tray portion when the dough rises within the gap.

8. The composite tray of claim 1, wherein each lower cup defines a substantially planar, circular bottom surface and an arcuate, ring-shaped sidewall.

9. The composite tray of claim 1, wherein each upper cup defines an arcuate, ring-shaped sidewall, with the sidewall of the upper cup having a different profile shape than a profile shape of the sidewall of the lower cup.

10. A method of baking a hollow bread product, the method comprising the steps of:
providing a composite tray comprising:
a tray portion comprising a plurality of lower cups; and
a cover portion comprising a plurality of upper cups, with each upper cup of the plurality of upper cups axially aligning with a respective lower cup of the plurality of lower cups;
placing bread dough within the plurality of lower cups;
resting the cover portion on the tray portion, with the cover portion being retained in place via gravitational forces, and with a predetermined gap being defined between the cover portion and the tray portion, and the plurality of lower cups and the plurality of upper cups sandwiching the bread dough within the predetermined gap.
